(19) United States
(12) Patent Application Publication
(10) Pub. No.: US 2010/0318439 A1
(43) Pub. Date: Dec. 16, 2010

(54) Simulated Live Auction Dynamics for On-line Automated Auctions by Running Auctions Past Their Bid Cut-off

(76) Inventor: Timothy Warren Brown, Zirconia, NC (US)

Correspondence Address: Timothy Brown, 108 Panther Mountain Rd, Zirconia, NC, 28790, US

(21) Appl. No.: 12/814,468

(22) Filed: Jun. 13, 2010

Related U.S. Application Data
(60) Provisional application No. 61/268,413, filed on Jun. 13, 2009.

(51) Int. Cl. G06Q 30/00

(52) U.S. Cl. 705/26

(57) ABSTRACT

I have developed an improvement to the process of online automated auctions that allows them to replicate the dynamics of live auctions with minimal complexity. This is done by changing the current auction cut-off time to a bid submittal cut-off and then continuing to run the auction (past the cut-off time) in the absence of external inputs. The auction will continue until the bidder who entered the highest maximum bid outbids the second highest bidder's maximum bid. In the current practice, the auction clock controls the auction dynamics and bidding strategy with bidders waiting till the last moment to bid hoping to win the item at a low price. In my method, the amount the bidders are willing to pay controls the auction just like in a live one.

This application for a nonprovisional utility patent claims the benefit of provisional patent U.S. 61/268,413.

I have developed an idea for a new and useful improvement to the process of automated on-line auctions. The current method of running on-line automated auctions lists an item with an ending time for the auction. This method results in a bidding strategy of waiting until the last moment to place a bid, hoping to win the item at a low price before another bidder can outbid them. Although there is nothing wrong with this approach, it is completely different from a live auction where the auctioneer adjusts the length of the auction based on bidder interest to get the highest possible price. My idea will allow an automated on-line auction to replicate a live one and thus raise average sale prices.

My idea is to change the current auction cut-off time to a bid submittal cut-off and then continue to run the auction (past the cut-off time) in the absence of external inputs. There are multiple ways to implement this idea. It will need to be used with a system similar to the one used by eBay® and most other online auctions—enter a bid and a maximum bid. The best implementation would be to search the maximum bids at the cut-off time and award the item to the highest maximum bid at one bidding interval above the second highest maximum bid. This method should require the least amount of computing power to implement. Another option would use the current code and block external bid inputs after the cut-off time and let the bidding run until it stops. Both methods have the same result; they differ only in programming the system. Notice that in both cases, there are no external inputs after the cut-off time. This fact is a crucial difference compared to previous attempts to replicate live-auction dynamics in an online auction. My method also has the advantage that it is extremely simple to implement and run unlike previous attempts like Bauer et. al. Although this is a very simple change, the idea deserves to be patented because it represents a paradigm shift in the dynamics and bidding strategies of automated on-line auctions. The clock is no longer the controlling factor in the auction; now the amount people are willing to pay controls the auction dynamics just like a live auction.

What is claimed is:

1. The method of running an online-automated auction where the auction continues to run after the bid-cutoff time; however, no external inputs are allowed after the bid-cutoff in this method.
